(19) United States
(12) Patent Application Publication
(10) Pub. No.: US 2015/0200972 A1
(43) Pub. Date: Jul. 16, 2015

(54) METHODS AND SYSTEMS FOR FACILITATING DECODING OF APPLICATION DEFINED OR PROPRIETARY PROTOCOLS IN LAWFUL INTERCEPTS

(71) Applicant: QUALCOMM Incorported, San Diego, CA (US)

(72) Inventors: Vijay Anandrao Suryavanshi, San Diego, CA (US); Mohammed Ataur Rahman Shuman, San Diego, CA (US)

(73) Assignee: QUALCOMM Incorporated, San Diego, CA (US)

(21) Appl. No.: 14/156,750

(22) Filed: Jan. 16, 2014

(51) Int. Cl. H04L 29/06

(52) U.S. Cl. CPC H04L 63/308; H04L 63/0428

(57) ABSTRACT

Embodiments include servers, systems, and methods for facilitating lawful interception of communication traffic generated by applications on communication devices and transmitted over wireless communication networks. An application identifier is included in communication traffic identifying the application generating the traffic. When the communication traffic is subject to lawful interception the application identifier may be used to determine an appropriate decode and/or decryption process and keys to decode/decrypt the communication traffic. Obtaining the appropriate decode and/or decryption process and keys based on an application identifier included in the communication may obviate the need for law enforcement servers to determine the appropriate process and keys through trial and error. Including an application identifier in communications may also enable lawful intercepts to be conducted based on particular applications generating the communication traffic.

### BACKGROUND

Lawful interception refers to the processes of monitoring telephone communications by a lawful authority for the purpose of analysis or evidence. Data obtained from lawful intercepts generally includes signaling, network management information, and/or the content of the communications (e.g., recorded conversations). There are many circumstances in which lawful intercepts of telephone communications may occur, including infrastructure protection and cybersecurity. One circumstance in which lawful interception maybe conducted involves the interception of telecommunications by law enforcement agencies (LEAs), regulatory or administrative agencies, and intelligence services in accordance with laws governing such activities.

The proliferation of wireless data applications on mobile devices has increased the amount of data wireless network operators may provide to the law enforcement agencies in a lawful intercept. While this volume of data may be useful to law enforcement authorities, wireless data applications frequently encrypt and encode the data using a variety of different methods that complicate decrypting and decoding the data for use by the law enforcement agencies. To decrypt or decode the data, the law enforcement agencies must first determine the proper method of decrypting or decoding the data. The combination of the volume of data provided by the wireless network operators to the law enforcement agencies, and the number of potential encrypting and/or encoding techniques applied to the data can significantly hinder the process of decoding the data obtained in a lawful intercept. Currently, each data packet may have to be run through a series of possible decryption and/or decoding methods until the correct method is found to decrypt or decode the data.

### SUMMARY

The various embodiments include methods, as well as servers and communication system implementing embodiment methods, for conducting lawful interception of communication traffic generated by an application on a mobile device transmitted over a wireless communication network. Embodiment methods may include receiving in a server communication traffic subject to lawful interception, determining whether the received communication traffic includes an application identifier associated with the application that generated the received communication traffic, using the application identifier to obtain information about the application that generated the received communication traffic, and using the obtained information about the application to process the received communication traffic for use by a law enforcement agency authorized to receive the communication traffic. The application identifier may be included in communication traffic by mobile devices to identify the application generating the communication traffic. The obtained information about the application that generated the received communication traffic may include one or more of a decoding process, a decryption process, and a decryption key. In an embodiment, operations of using the obtained information about the application to process the received communication traffic for use by a law enforcement agency may include decoding the communication traffic using a decoding process obtained using the application identifier. In another embodiment, operations of using the obtained information about the application to process the received communication traffic for use by a law enforcement agency may include decrypting the communication traffic using a decryption process and a decryption key obtained using the application identifier. In an embodiment, operations of using the application identifier to obtain information about the application that generated the received communication traffic may include using the application identifier as look-up parameter to perform a look-up operation on a database to obtain the information about the application from a database field correlated to the application identifier. In an embodiment, operations of receiving via the network interface communication traffic subject to lawful interception may include receiving the application identifier along with the communication traffic over an X2 interface of the wireless communication network when the communication traffic includes signaling traffic and over an X3 interface of the wireless communication network when the communication traffic includes media traffic.

Another embodiment includes a server configured to perform the operations of the methods described above. Another embodiment includes a non-transitory server-readable medium having stored thereon server-executable instruction configured to cause a server to perform the operations of the methods described above. Another embodiment includes a communication system that includes a wireless communication network, a mobile device configured to include an application identifier in communication traffic that identifies an application that generated the communication traffic, and a server in communication with the wireless communication system configured to perform the operations of the methods described above.

### BRIEF DESCRIPTION OF THE DRAWINGS

The accompanying drawings, which are incorporated herein and constitute part of this specification, illustrate embodiments of the invention, and together with the general description given above and the detailed description given below, serve to explain the features of the invention.

FIG. 1 is a component block diagram illustrating a wireless communication system configured to facilitate lawful interception of mobile application communications in accordance with an embodiment.

FIG. 2 is a component block diagram illustrating a server within a wireless communication network configured to facilitate lawful interception of mobile application communications in accordance with an embodiment.

FIG. 3 is a functional block diagram of a system for lawful interception of mobile application communications over a wireless network in accordance with an embodiment.

FIG. 4 is a process flow diagram illustrating an embodiment method for identifying a mobile application related to mobile application communications sent over a wireless network to facilitate lawful interception of the mobile application communications over the wireless network.

FIG. 5 is a process flow diagram illustrating an embodiment method for filtering mobile application communications received on the wireless network according to parameters of lawful interception.

FIG. 6 is a process flow diagram illustrating an embodiment method for identifying filtered mobile application communications received on the wireless network and providing law enforcement agencies with information facilitate the lawful interception.

FIG. 7 is component block diagram illustrating an example mobile device suitable for use with the various embodiments.

FIG. 8 is component block diagram illustrating an example computing device suitable for use with the various embodiments.

FIG. 9 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor, circuitry for communicating with a cellular telephone and/or data network.

Mobile applications loaded on and executed by mobile devices may use proprietary coding and cryptographic processes, functions, and keys for encoding/decoding and/or encrypting/decrypting communication traffic sent between mobile devices and users of the mobile applications. For this reason, lawful intercepts may collect a large volume of data that is encoded using processes, functions and keys that are unknown to the law enforcement agency. Determining the coding and cryptographic processes used by any mobile application to encode/encrypt data received in a lawful intercept may require extensive time and resources for employing a trial and error approach to decode and/or decrypt the communication traffic. The party implementing the lawful interception may employ a variety of search techniques to select coding and/or cryptographic processes, functions, and keys to apply to the communication traffic, but such efforts remain a trial and error process.

To overcome these problems, the various embodiments provide processes that may be implemented in mobile devices to encode information that can inform a law enforcement agency server of the encoding processes and keys used by an application executing on a mobile device to facilitate the decoding and use of data obtained in a lawful intercept. In an embodiment, a mobile application may provide an application identifier along with the communication traffic it generates such that the party implementing the lawful interception may identify the application that generated the communication traffic subject to lawful interception. The application identifier may be transmitted from the mobile device across X-interfaces of wireless communications networks to the party implementing the lawful interception. The application identifier may be used by a server controlled by the party implementing the lawful interception to select the appropriate coding and/or cryptographic processes, functions, and keys to format the communication traffic into a format readable by a law enforcement agency that requested the lawful interception.

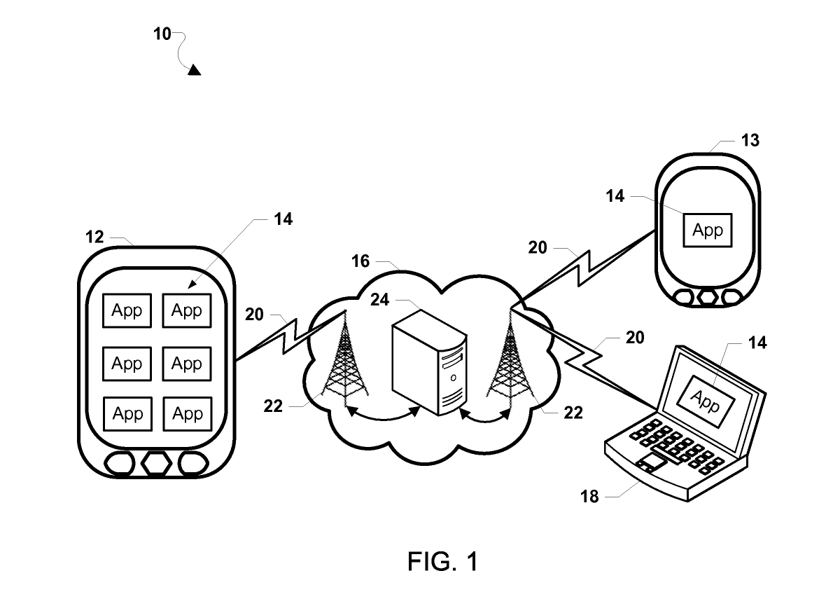

FIG. 1 illustrates a wireless communication system suitable for implementing the various embodiments. The wireless communication system 10 may include mobile devices 12, 13 and computing devices 18 in communication with each other over a wireless network 16. The mobile devices 12, 13 and the computing devices 18 may communicate via the wireless network 16 through wireless connections 20 between mobile devices 12, 13 and computing devices 18 and base stations 22 of the wireless network 16. The base stations 22 may route the communication traffic through servers 24 of the wireless communication network 16. The servers 24 may include a variety of wireless communication network components configured to route the communication traffic through the wireless network to its intended destination, such as computing devices 18. The servers 24 may also include wireless communication network components configured to facilitate lawful interception of the communication traffic. Servers 24 configured to facilitate lawful interception may include components configured to identify communication traffic subject to lawful interception, components to filter the identified communication traffic, and components to provide the identified communication traffic to the law enforcement agencies.

Mobile devices 12, 13 may be configured with a number of mobile applications (apps) 14, which may be preloaded on the mobile devices 12, 13, downloaded by a user of the mobile devices 12, 13, or pushed to the mobile devices 12, 13 by a wireless network operator of the wireless network 16. The mobile applications 14 may be published or provided by the wireless network operators, or by a third party application developer or vendor. The mobile applications may 14 transfer data to or from the mobile devices 12, 13 as part of the communication traffic transmitted over a wireless network 16. In an embodiment, the data transferred to the mobile devices 12, 13 may originate at another computing device 18, which may be a private or public device, or at the wireless network 16. Similarly, in an embodiment, the data transferred from the mobile devices 12, 13 may terminate at the other computing device 18, being either a private or public device, or at the wireless network 16. The data transferred to or from the mobile devices 12, 13 may be encoded and/or encrypted to facilitate reliable wireless communications and, in some cases, to prevent an unauthorized party from viewing the data. The mobile applications 14 may use one of more processes to encode and/or encrypt the data.

Data produced or received by the applications 14 may be single-encoded and/or encrypted according to various processes. In other words, a single-encode mobile application 14 may use a first coding and/or cryptographic process to encode and/or encrypt, or decode and/or decrypt a first data and a second coding and/or cryptographic process to encode and/or encrypt, or decode and/or decrypt a second data. On the other hand, data produced or received by other mobile applications 14 may be encoded and/or encrypted in multiple layers (“multi-encoded) according to various processes. In other words, a multi-encoded mobile application 14 may use the first coding and/or cryptographic process to encode and/or encrypt, or decode and/or decrypt the first data and the second coding and/or cryptographic process to encode and/or encrypt, or decode and/or decrypt the first encoded and/or encrypted data. The number of data and coding and/or cryptographic processes described in this example are not meant to be limiting as the numbers of encoding and encryption layers implemented by mobile device applications may vary. For ease of reference, the examples and descriptions herein may refer to encoding/decoding or encrypting/decrypting. It should be understood that reference to either encoding/decoding or encrypting/decrypting is not meant to be limiting, and descriptions and examples relating to encoding/decoding or encrypting/decrypting may also apply to the other.

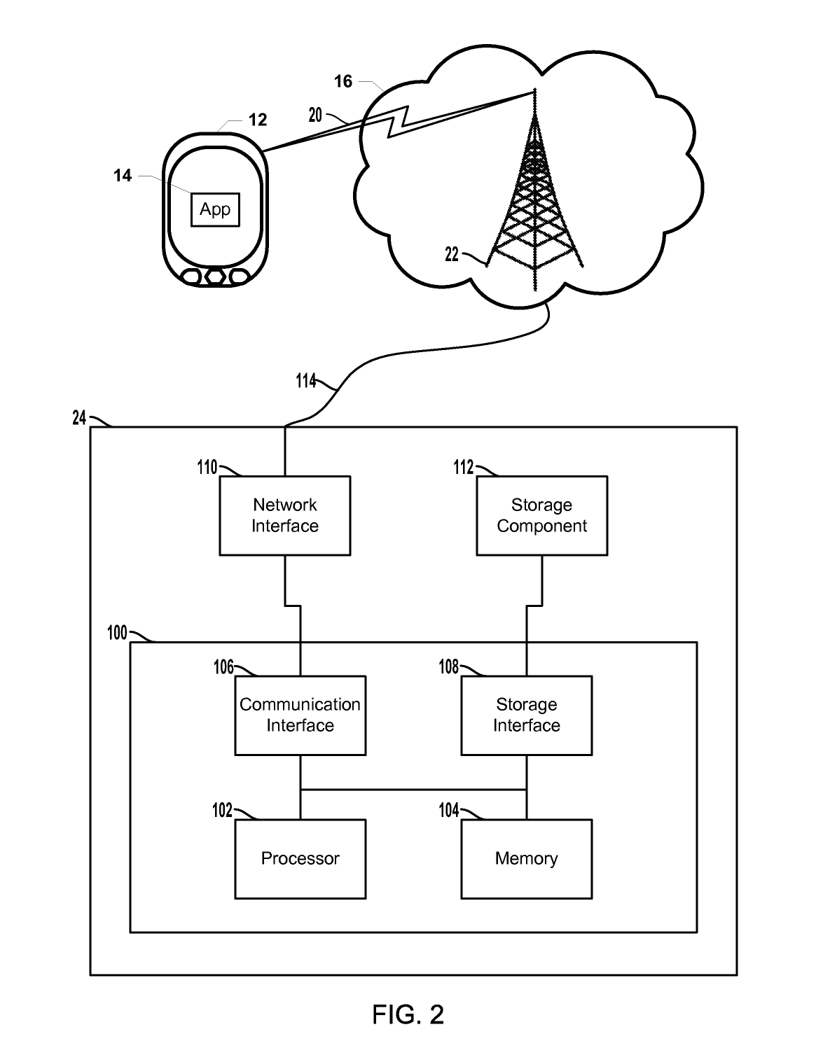

FIG. 2 illustrates a server 24 in wireless network configured to facilitate lawful interception of mobile application communications over a wireless network. The server 24 may include a processor 102, a memory 104, a communication interface 106, and a storage interface 108 that may be integrated on a single circuit board 100. The server 24 may further include a storage component 112 and a network interface 110 coupled to the wireless communication network 16 by a network connection 114.

The memory 104 may be a volatile or non-volatile memory configured for storing data and process code for access by the processor 102. In an embodiment, the memory 104 may be configured to, at least temporarily, store encoded/decoded and encrypted/decrypted communication traffic transferred across the wireless network 16 between a mobile device 12 and other mobile devices 13 or computing devices 18. The memory 104 may also be configured to store the communication traffic and related information, such as an application identifier (described below), for sending to other servers 24 configured to facilitate lawful interception and deliver the communication traffic to law enforcement agencies. The information related to the communication traffic stored in the memory 104 may further include lawful interception parameters identifying the mobile devices 12 and the communication traffic subject to lawful interception, and coding and/or cryptographic information of the communication traffic for decoding and/or decrypting the communication traffic. The server 24 may include one or more memories 104 configured for various purposes. In an embodiment, one or more memories 104 may be configured to be dedicated to storing the communication traffic and related information, such that the stored communication traffic and related information may be accessed by one or more processors 102.

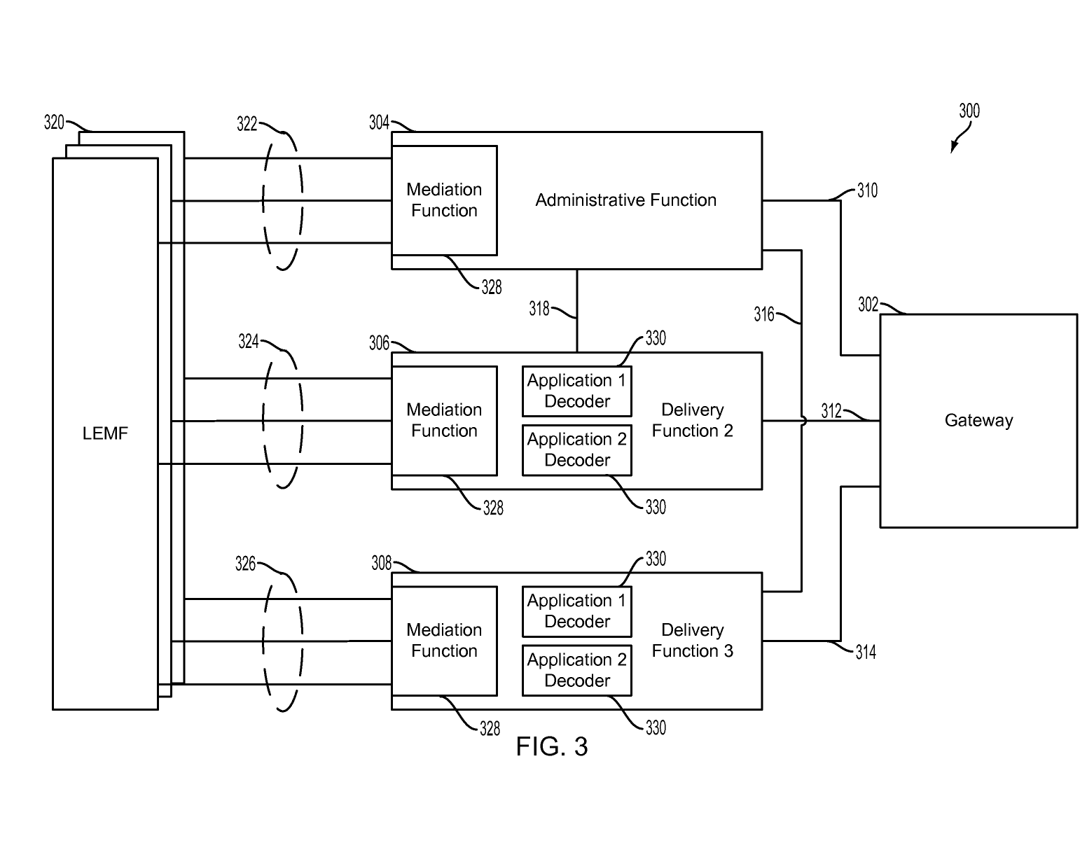

The communication interface 106 and the network interface 114 may work in unison to enable the server 24 to communicate with the wireless network 16 and the other servers of the wireless network 16 via wired connections 114. The wireless network 16 may be implemented using a variety of wireless communication technologies, including, for example, radio frequency spectrum used for wireless communications, to facilitate communication between the mobile device 18 and the servers 24. In an embodiment, the wireless network 16 and wired or wireless connections 20 may be used to communicate communication traffic of the mobile applications 14 between the mobile devices 12, 13 and the other computing devices 18. In another embodiment, the wireless network 16 and the wired or wireless connections 20 may be used to communicate the communication traffic subject to lawful interception, and information related to this communication traffic between the servers 24, some of which may belong to the wireless network operator, to third party service providers, and to law enforcement agencies. The communication interface 106 may receive communication traffic and/or related information from the processor 102, and provide the communication traffic and/or related information to the network interface 110. The network interface 110 may be configured to establish the wired connection 114 to the wireless network 16 and prepare communication traffic and/or related information for transmission. The network interface 110 may transmit the communication traffic and/or related information over the wired connection 114 to the wireless network 16 and network servers (not shown in FIG. 3) where the communication traffic and/or related information may be routed via other servers to the destination mobile devices 12 or computing devices. The network interface 110 may also receive communication traffic and/or related information on the wired connection 114, transmitted by the mobile devices 12, 13, computing devices 19, and servers 24 over and within the wireless network 16. The network interface 110 may receive the communication traffic and/or related information and prepare the communication traffic and/or related information for use by network servers. The communication interface 106 may receive the prepared communication traffic and/or related information from the network interface 110 and provide the prepared communication traffic and/or related information to the appropriate components of the server 24, such as the processor 102, the memory 104, and the storage component 112.

The storage interface 108 and the storage component 112 may work together to allow the server 24 to store the communication traffic and/or related information on a non-volatile storage medium. The storage component 112 may be configured much like an embodiment of the memory 104, and the storage component 112 may store the communication traffic and/or related information, such that the communication traffic and/or related information may be accessed by one or more processors 102. The storage component 112, being non-volatile, may retain the information of the communication traffic and/or related information even after the power of the server 24 has been shut off. The storage interface 108 may control access the storage component 112 and allow the processor 102 to read data from and write data to the storage component 112.

Some or all of the components of the server 24 may be differently arranged and/or combined while still serving the necessary functions. Moreover, the server 24 may not be limited to one of each of the components, and multiple instances of each component, in various configurations, may be included in the server 24. Rather than a single server implementing the various embodiments, the embodiments may be implemented within a combination of multiple servers in which each server may be configured for different purposes.

In the various embodiments, each mobile application 14 on the mobile devices 12, 13 may be assigned or associated with an application identifier. This application identifier may be associated with the corresponding application in a database of applications that may be accessible by a law enforcement server (or other servers supporting a lawful intercept). This database of applications may correlate the application identifier with a database field storing the type of encryption and/or encoding used by the application for transmitting data over communication networks. In an embodiment, the mobile application 14 may include the application identifier along with the communication traffic sent by the application from the mobile devices.

The application identifier may be unique to each mobile application that may be implemented on mobile devices, such that no two applications have the same application identifier. The application identifier may further uniquely identify particular versions of applications, such with the use of a version extension so that no two versions of an application have the same application identifier. Alternatively, the application identifier may be unique to the particular type of encoding or encryption method/keys used by an application, such that multiple applications using the same encoding or encryption method/keys may be associated with the same application identifier.

In another embodiment, a process within the operating system or communication software may relate the communication traffic to the mobile application that generated the communication traffic and add the application identifier to the communication traffic sent by the mobile application 14, such as in a packet header. In yet another embodiment, the process within the operating system or communication software may include the application identifier in a separate communication channel, such as an overhead channel communicating with the wireless network.

In an embodiment, the application identifier may be available for mobile applications published or provided by the wireless network operators. Wireless network operators may assign application identifiers voluntarily or may be required to include the application identifier with communication traffic of the mobile applications for which the wireless network operators have at least some involvement in the mobile application. In an embodiment, application developers may be required to include the unique application identifier within the application software. In an embodiment, the application identifier may be encoded/decoded and/or encrypted/decrypted according to a coding and/or cryptographic process known by the wireless network operators, third party service providers, and/or law enforcement agencies.

In a Third Generation Partnership Project (3GPP) wireless network 16, such as a wireless network employing the Long Term Evolution (LTE) protocol, a wireless network operator may manage a portion of the wireless network to provide for lawful interception of communication traffic when requested by a law enforcement agency according to the applicable laws, like the Communications Assistance for Law Enforcement Act (CALEA). General purpose portions of the wireless network used for standard wireless communication may interface with portions of the wireless network specifically purposed for lawful interception. The lawful interception portions of the wireless network may also interface with networks or facilities maintained for use by or to provide support to law enforcement agencies. An example communication system architecture of such portions of a wireless network for lawful interception is illustrated in FIG. 3.

FIG. 3 illustrates a system for lawful interception of mobile application communications over a wireless network. The wireless network 16 may include a number of network components, including a gateway (GW) 302, an administrative function (ADMF) 304, a delivery function 2 (DF2) 306, and a delivery function 3 (DF3) 308, which are defined in the 3GPP Technical Specification 33.107.

The gateway (GW) 302 typically functions to connect networks or portions of networks to each other. For example, the server 24 illustrated in FIG. 1 may be a gateway 302. The gateway 302 in an 3GPP wireless network 16 implementing LTE communication may include a serving gateway and/or a packet data network gateway (PDN-GW). The gateway 302 may interface with the lawful interception portions of the wireless network. An interface between the gateway 302 and the lawful interception portions of the wireless network may be implemented using X-interfaces (X1_{—}1 310, X2 312, and X3 314). X-interfaces (X1_{—}2 318 and X1_{—}3 316) may also exist between the lawful interception portions of the wireless network. Requirements for the communication traffic transmitted by the X-interfaces 310, 312, 314, 316, 318 are defined in 3GPP Technical Specification 33.107, which is incorporated by reference herein. However, structure or methodologies for implementing the X-interfaces 310, 312, 314, 316, 318 are not defined.

The lawful interception portions of the wireless network 16 may include Handover interfaces (HI1 322, HI2 324, and HI3 326), defined in 3GPP Technical Specification 33.108, which is incorporated by reference herein, may transmit information between the lawful interception portions of the wireless network and the networks maintained for use by the law enforcement agencies 320, or law enforcement agency monitoring facilities (LEMFs).

As discussed above the X-interfaces 310, 312, 314 may transmit information between the gateway 302 and the lawful interception portions of the wireless network. The X1_{—}1 interface 310 may connect the gateway 302 and the administrative function 304 of the lawful interception portions of the wireless network. Messages sent across the X1_{—}1 interface 310, from the administrative function 304 to the gateway 302, may include administrative information associated with a particular lawful interception. Such administrative information may include an identity of a target for lawful interception, the communication traffic to intercept, which may be identified by the application identifier, an address of delivery function 2, an address of delivery function 3, and an interception area when lawful interception is location dependent.

The X2 interface 312 may connect the gateway 302 and the delivery function 2 306 of the lawful interception portions of the wireless network. Communication traffic sent across the X2 interface 312, from the gateway 302 to the delivery function 2 306, may include signaling traffic information associated with the instance of lawful interception. Such signaling traffic information may include the identity of the target for lawful interception, a target location or the interception area when lawful interception is location dependent, a correlation number, a quality of service (QoS) identifier, encryption parameters for an intercepted content of communications (if available), events and associated parameters, and applications identifiers.

Messages sent across the X3 interface 314, from the gateway to the delivery function 308, may include media traffic information associated with the instance of lawful interception. Such media traffic information may include the intercepted content of communications, the identity of the target for lawful interception, the correlation number, a time stamp, a direction (mobile originated or mobile terminated), the target location or interception area when lawful interception is location dependent, and application identifiers.

The administrative function 304 of the lawful interception portions of the wireless network may be used to receive from the law enforcement monitoring facility 320, and provision to the gateway 302, the administrative information associated with the instance of lawful interception. The delivery function 2 306 of the lawful interception portions of the wireless network may be used to receive from the gateway 302, and distribute to the law enforcement monitoring facility 320, the signaling traffic information associated with the instance of lawful interception. The delivery function 3 308 of the lawful interception portions of the wireless network may be used to receive from the gateway 302, and distribute to the law enforcement monitoring facility 320, the media traffic information associated with the instance of lawful interception. Together, the administrative function 304 and the delivery functions 306, 308 may be used to hide the law enforcement agencies targeting a mobile devices 12, 13 from the mobile devices 12, 13 and its users.

A mediation function 328 may be separate function or included as part of the administrative function 304 and/or the delivery functions 306, 308. The mediation function(s) 329 may convert the information transmitted on the handover interfaces 322, 324, 326, including the communication traffic subject to lawful intercept, to a format used by the receiving entity, such as a national or regional law enforcement monitoring facility 320, or the administrative function 304 to send to the gateway 302.

Each delivery function 306, 308 may include an application key 330, such as an application decoder or decrypter, for the mobile applications used by mobile devices. The application decoder/decrypter 330 may be specific to each mobile application, or to each encoding/encryption method/keys used by commercial applications. When communication traffic is received by the delivery function 2 306 and the delivery function 3 308 over the X2 interface 312 and the X3 interface 314, respectively, the delivery functions 306, 308 may attempt to apply each application decoder/decrypter 330 to the communication traffic.

In an embodiment, when the communication traffic received by the delivery functions 306, 308 include the application identifier associated with the mobile application 14 which sent, or was intended to receive, the communication traffic, the delivery functions 306, 308 may use the application identifier to identify an appropriate application decoder/decrypter 330 process and/or decryption key. This may be accomplished by a server using the application identifier as a lookup parameter for accessing a database of mobile device applications or application decoder/decrypter methods and keys using a look-up operation. By obtaining from that database the application decoder/decrypter methods and keys corresponding to the application identifier by accessing a database field corresponding or linked to the application identifier, the delivery functions 306, 308 may be able to determine a decoding process, a decryption process, and/or a decryption key to use in order to decode and/or decrypt communications from the application obtained during the lawful intercept without having to perform a trial and error analysis in order to discover the appropriate decoder/decrypter methods and keys.

In an embodiment, the lawful interception portions of the wireless network, including the administrative function 304, the delivery function 2 306, the delivery function 3 308, the mediation function 328, and the application decoders 330 may be differently arranged and/or combined while still serving the necessary functions. The lawful interception portions of the wireless network may be implemented in one or more servers configured to execute some of the embodiment methods described herein.

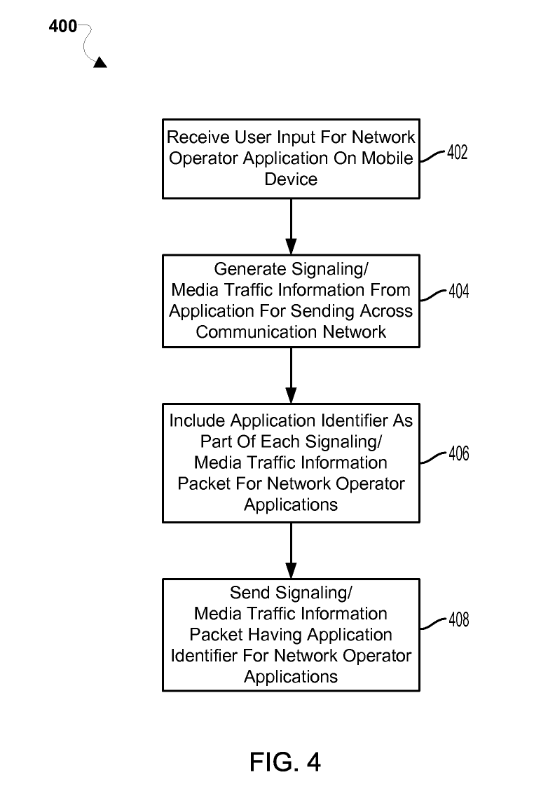

FIG. 4 illustrates an embodiment method 400 for identifying a mobile application generating communications sent over a wireless network to facilitate lawful interception of the mobile application communications. The mobile device processor may be configured to execute method 400.

In block 402 the mobile device processor may receive user input (e.g., a user interaction with a keyboard, touch screen, microphone, button, switch, or sensor of the mobile device) to begin communications via a wireless network using a particular mobile application. Such mobile applications may be published or provided by the wireless network operator preloaded to the mobile device at the time of a user purchasing the mobile device, as well as applications downloaded by the user or pushed to the mobile device. The user interaction may also be indirect in which the user causes a state of the mobile device to change without intentionally interacting with the mobile device, such as changing location as may be detected by a global positioning system (GPS) application.

In block 404, the mobile device may generate communication traffic, including signaling and/or media traffic information, from the mobile application for sending across the wireless communication network.

In block 406, the mobile device may include an application identifier as part of the communication traffic. The application identifier may be provided by the mobile application generating the communication traffic. Alternatively, the application identifier may be appended to application-generated communication data by a process within a supervisor each function or high-level operating system of the mobile device. The application identifier may be included in a portion of the transmitted data that can be easily identified, understood and used by a server supporting the lawful intercept. For example, the application identifier may be appended to the communication traffic after encoding and/or encrypting so that the identifier can be read without decoding/decrypting. The application identifier may be included in packet headers so that the decryption/decoding method can be determined on a packet-by-packet basis. Alternatively, the application identifier may be included in the call-establishment metadata that may be captured and provided to law enforcement server as part of a lawful intercept.

In an embodiment, the application identifier may be included in the signal and/or media traffic information by processes that cannot be interfered with by users or unauthorized third parties. In an embodiment, the application identifier may be added by a process executing within a portion of the mobile device operating system that is protected from tampering. For example, portions of the process adding the application identifier may be executed within a trust zone of the processor. In a further embodiment, wireless network communication protocols may be revised to reject any wireless communications that does not include an application identifier, or includes an application identifier that is inconsistent with the type of communication or applications registered on the mobile device.

In block 408, the mobile device may send the communication traffic, including the application identifier to a destination device across the wireless communication network, where the traffic may be subject to lawful interception.

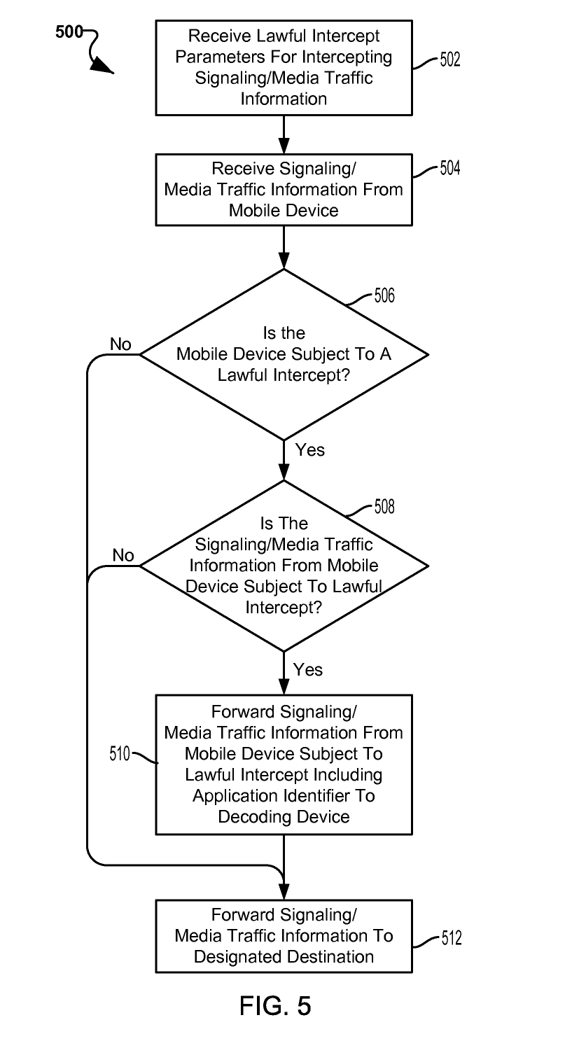

FIG. 5 illustrates an embodiment method 500 that may be implemented in a server for conducting a lawful intercept from a wireless network. In block 502, the server may receive messages over the X_{—}1 interface from a law enforcement authority to initiate a lawful intercept including the parameters necessary for the wireless network to lawfully intercept communication traffic from an identified mobile device. These messages may specify the mobile device by telephone number and the communication traffic subject to lawful interception, which may include signaling and media traffic. In an embodiment, the targeted media traffic may be identified by the application identifier so that only those media packets including the specified application identifier are captured in the lawful intercept. As described above, other parameters may include an address of delivery function 2, an address of delivery function 3, and an interception area when lawful interception is location dependent.

In block 504, the server may receive communication traffic from the mobile device as the traffic passes through the wireless network. In determination block 506, the server may determine whether the mobile device from which the server received the communication traffic is the subject to lawful interception according to the parameters received over the X1_{—}1 interface in block 502. The server may analyze the received communication traffic for information identifying the mobile device which sent, or was intended to receive, the communication traffic and compare the information to the identifying information provided over the X1_{—}1 interface as part of the lawful interception parameters.

When the server determines that the received communication traffic is not from a mobile device subject to lawful interception (i.e., determination block 506=“No”), the server may forward the communication traffic to its designated destination in the ordinary manner in block 512.

When the server determines that the communication traffic is from a mobile device subject to lawful interception (i.e., determination block 506=“Yes”), in determination block 508 the server may determine whether the communication traffic from the mobile device subject to lawful interception is communication traffic that is subject to that lawful interception. The server may analyze the communication traffic from the mobile device subject to lawful interception and compare characteristics of the communication traffic to the parameters for lawful interception related to the communication traffic subject to lawful interception. Such parameters and characteristics of the communication traffic may include the type of the communication traffic, for example, whether the communication traffic is signaling or media traffic and the type signaling or media. In an embodiment, this determination may be made based on the application identifier of the mobile application that generated the communication traffic. Thus, the application identifier may be used for filtering communication packets that are subject to a particular lawful intercept from other communication packets that are not subject to the lawful intercept.

When the server determines that the communication traffic from the mobile device subject to lawful interception is not subject to lawful interception (i.e., determination block 508=“No”), the server may forward the communication traffic to its designated destination in the ordinary manner in block 512.

When the server determines that the communication traffic from the mobile device subject to lawful interception is subject to lawful interception (i.e., determination block 508=“Yes”), the server may forward a copy of the communication traffic to a designated component of the lawful interception portion of the wireless communication network in block 510. As part of the operations of block 510, the server may distinguish signaling traffic from media traffic, route a copy of the signaling traffic to the X2 interface and to the delivery function 2, and route a copy of the media traffic to the X3 interface and to the delivery function 3. The server may be configured to send the communication traffic subject to lawful interception to the appropriate delivery function over the appropriate X-interface according to a predetermined configuration or according to the addresses of the delivery functions provided in the lawful interception parameters from the administrative function.

In block 512 the server may also forward the communication traffic to its original designated destination as provided by the mobile device and/or the mobile application such that the sender and the recipient of the communication traffic are unaware of the lawful interception of the communication traffic.

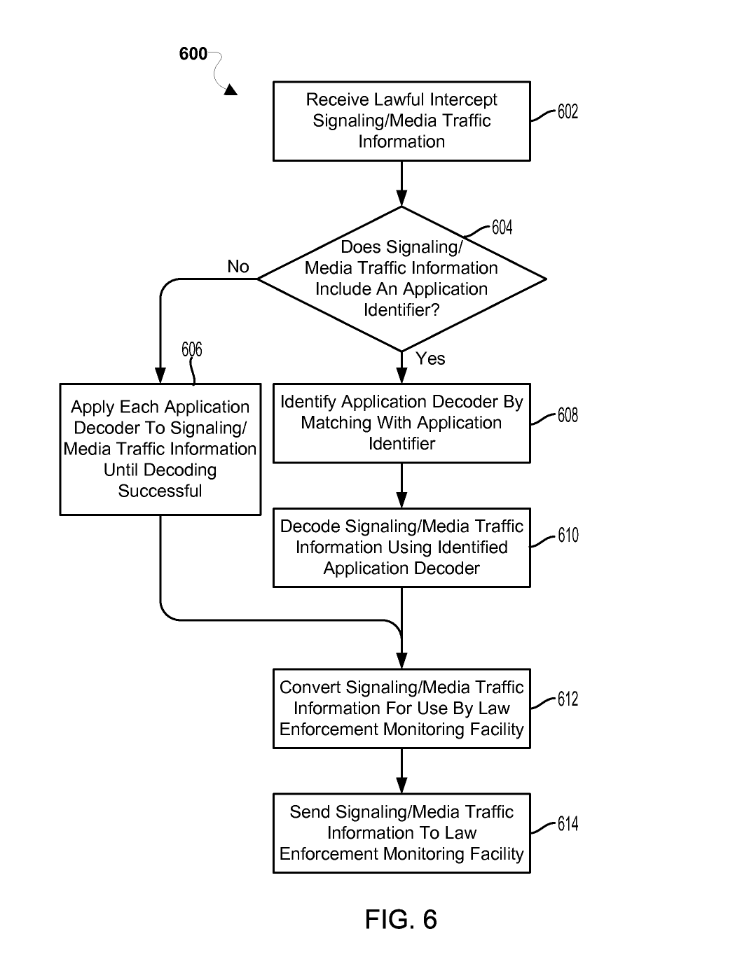

FIG. 6 illustrates an embodiment method 600 that may be implemented in a server of the lawful intercept portion of the wireless network for identifying filtered mobile application communications received on the wireless network and providing law enforcement agencies with information facilitate the lawful interception.

In block 602 the server may receive the copied communication traffic obtained pursuant to the lawful interception described above with reference to FIG. 5. The delivery function 2 may receive signaling traffic subject to lawful interception over the X2 interface. The delivery function 3 may receive media traffic subject to lawful interception over the X3 interface.

In determination block 604, the server may determine whether the received communication traffic subject to lawful interception includes an application identifier. The application identifier may be appended to the communication traffic (e.g., in packet headers) in the open or encoded and/or encrypted according to coding/cryptographic processes know to the server so that the server may obtain the application identifier by applying the known processes to the portions of the communication traffic including the application identifier.

When the server determines that the communication traffic subject to lawful interception does not include an application identifier (i.e. determination block 604=“No”), the server may use current processes to discover the appropriate decoders and/or decrypters through trial and error by applying each until the traffic is successfully decoded in block 606. In this operation the server may employ a variety of know search algorithms to select decoders and/or decrypters from the groups of each stored on the server. When the appropriate decoders and/or decrypters are determined they may be used to decode all of the received communication traffic.

When the server determines that an application identifier is present along with the communication traffic subject to lawful interception (i.e. determination block 604=“Yes”), the server may use the application identifier to determine or obtain the application key, the decoder and/or decrypter associated with the mobile application that generated the communication traffic in block 608. The server may include or have access to a database associating application identifiers with the appropriate the decoders and/or decrypters. Thus in block 608, when an application identifier is received, the server may use the application identifier as a look-up parameter in a look-up operation for accessing the database to access a database field storing one or more of a decoding process, a decryption process and a decryption key (referred to herein as the decoders and/or decrypters) for decoding/decrypting data encoded/encrypted by the application associated with the application identifier. By including the application identifier with the communication traffic transmitted to the server over the X-interfaces, the server may avoid the time and resource consuming trial and error approach of applying multiple application decoders and/or decrypters to the received communication traffic to attempt to decode and/or decrypt the communication traffic of the mobile applications. Using the application identifier, the server may identify one or more application decoders and/or decrypters associated with the received communication traffic and efficiently decode and/or decrypt the received communication traffic for sending to the law enforcement agencies.

In block 610 the server may apply the application key, decoders and/or decrypters obtained based on the application identifier to decode and/or decrypt the communication traffic subject to lawful interception. Applying the decoders and/or decrypters may format the communication traffic subject to lawful interception into a format readable by the requesting law enforcement agencies.

In block 612, the server may convert the decoded and/or decrypted communication traffic obtained in either block 606 or block 610 to a format suitable for transmitting across the handover interfaces to the law enforcement agency conducting or responsible for the lawful intercept.

In block 614, the server may send the decoded and/or decrypted communication traffic subject to lawful interception for delivery to the law enforcement agency authorized to lawfully intercept the communication traffic. In an embodiment, the communication traffic may be decoded and/or decrypted signaling traffic, and the signaling traffic may be sent by the delivery function 2 to the law enforcement monitoring facility over the HI2 interface. In another embodiment, when the communication traffic includes decoded and/or decrypted media traffic, and the media traffic may be sent by the delivery function 3 to the law enforcement monitoring facility over the HI3 interface.

In an embodiment, the server may identify the decoder and/or decrypter for the communication traffic subject to lawful interception and rather than decode and/or decrypt the communication traffic, as in block 612, the server may send the communication traffic with the identified decoding and/or decrypting information to the law enforcement agency authorized to lawfully intercept the communication traffic. In such an embodiment, the receiving law enforcement agency may more easily decode and/or decrypt the received communication traffic.

It should be noted that any of the methods described and executed by the server may be executed by multiple servers of the wireless communication network, the lawful intercept portions of the wireless network managed by the wireless network operator, a third party service vendor, or the law enforcement agencies.

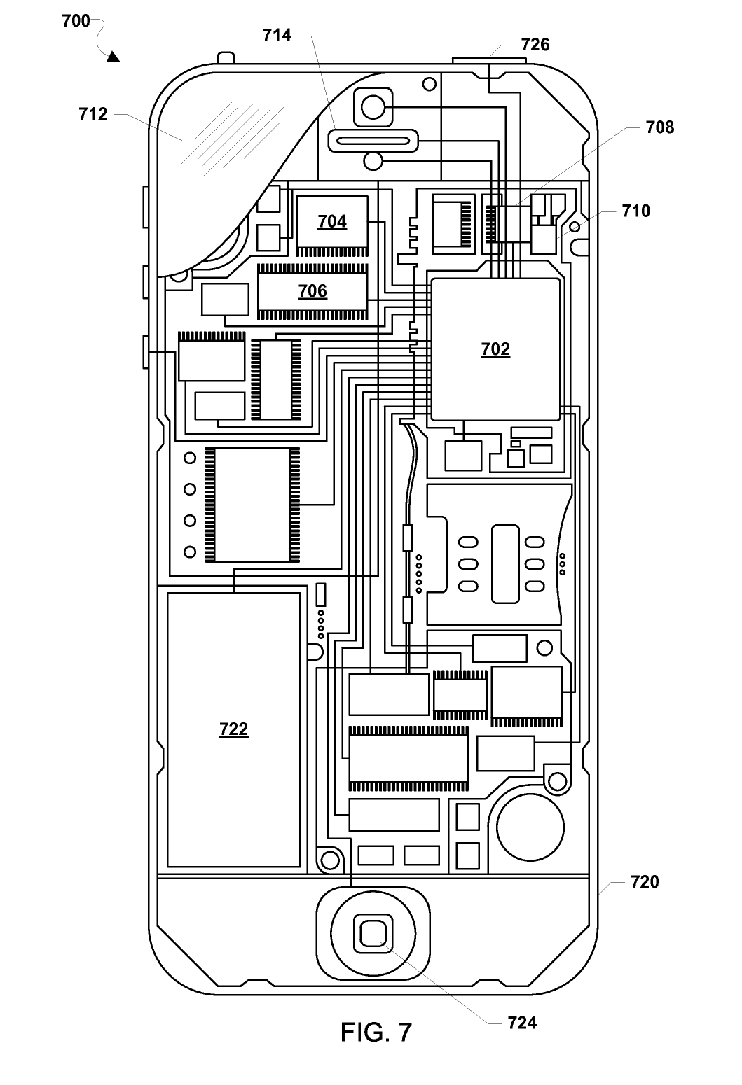

FIG. 7 illustrates an example of a mobile device suitable for use with the various embodiments. The mobile device 700 may include a processor 702 coupled to a touchscreen controller 704 and an internal memory 706. The processor 702 may be one or more multicore integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the computing device 700 need not have touch screen capability.

The mobile device 700 processor 702 may also be coupled to one or more cellular telephone and data transceivers 708 and antennae 710 for sending and receiving communications via a cellular telephone/data network, such as CDMA, GSM, LTE, 3G, or 4G network. The transceivers 708 and antennae 710 may be used with the above-mentioned circuitry to implement the various wireless transmission protocol stacks and interfaces to support cellular telephone and data network communications.

The mobile device 700 may also include speakers 714 for providing audio outputs. The mobile device 700 may also include a housing 720, constructed of a plastic, metal, or a combination of materials, for containing all or some of the components discussed herein. The mobile device 700 may include a power source 722 coupled to the processor 702, such as a disposable or rechargeable battery. The rechargeable battery may also be coupled to the peripheral device connection port to receive a charging current from a source external to the mobile device 700. The mobile device 700 may also include a physical button 724 for receiving user inputs. The mobile device 700 may also include a power button 726 for turning the mobile device 700 on and off.

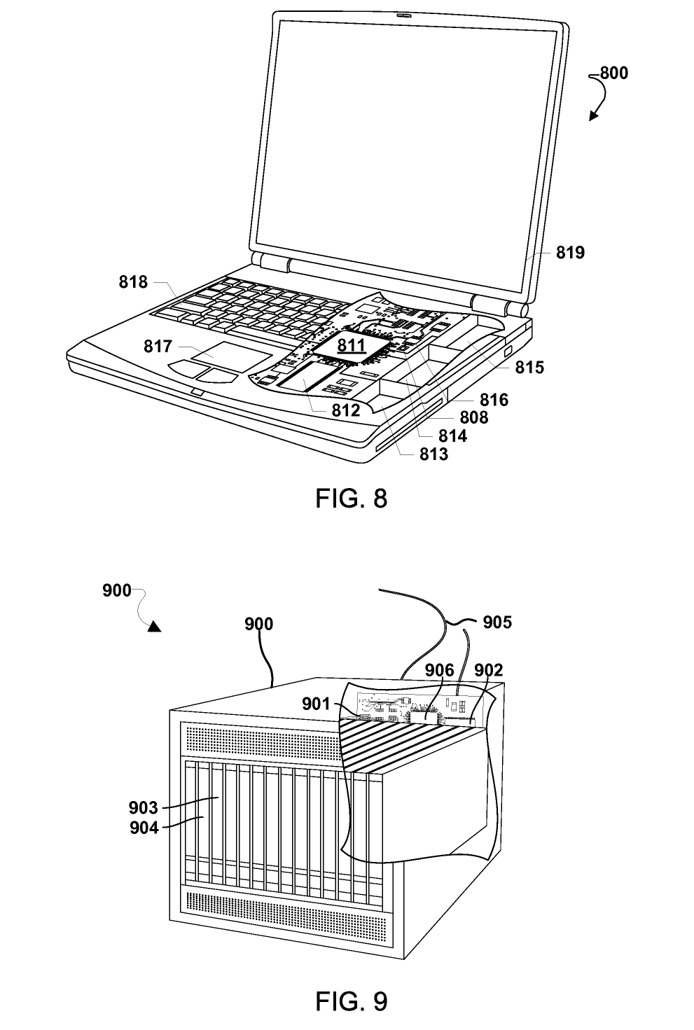

The various embodiments described above may also be implemented within a variety of computing devices, such as a laptop computer 800 as illustrated in FIG. 8. Many laptop computers include a touchpad touch surface 817 that serves as the computer's pointing device, and thus may receive drag, scroll, and flick gestures similar to those implemented on computing devices equipped with a touch screen display and described above. A laptop computer 800 will typically include a processor 811 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 811. The computer 800 may also include a floppy disc drive 814 and a compact disc (CD) drive 815 coupled to the processor 811. In a notebook configuration, the computer housing includes the touchpad 817, the keyboard 818, and the display 819 all coupled to the processor 811. Other configurations of the computing device may include a computer mouse or trackball coupled to the processor (e.g., via a USB input) as are well known, which may also be use in conjunction with the various embodiments.

The various embodiments may also be implemented on any of a variety of commercially available server devices, such as the server 900 illustrated in FIG. 12. Such a server 900 typically includes a processor 901 coupled to volatile memory 902 and a large capacity nonvolatile memory, such as a disk drive 904. The server 900 may also include a floppy disc drive, compact disc (CD) or DVD disc drive 906 coupled to the processor 901. The server 900 may also include network access ports 903 coupled to the processor 901 for establishing network interface connections with a network 907, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 702, 811 and 901 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 706, 812, 813, 902, 904 before they are accessed and loaded into the processors 702, 811 and 901. The processors 702, 811 and 901 may include internal memory sufficient to store the application software instructions. In many devices the internal memory may be a volatile or nonvolatile memory, such as flash memory, or a mixture of both. For the purposes of this description, a general reference to memory refers to memory accessible by the processors 702, 811 and 901 including internal memory or removable memory plugged into the device and memory within the processor 702, 811 and 901 themselves.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for lawful interception of communication traffic generated by an application on a mobile device transmitted over a wireless communication network, comprising:
receiving communication traffic subject to lawful interception;
determining whether the received communication traffic includes an application identifier associated with the application that generated the received communication traffic;
using the application identifier to obtain information about the application that generated the received communication traffic; and
using the obtained information about the application to process the received communication traffic for use by a law enforcement agency authorized to receive the communication traffic.

2. The method of claim 1, wherein the obtained information about the application that generated the received communication traffic comprises one or more of a decoding process, a decryption process, and a decryption key.

3. The method of claim 1, wherein using the obtained information about the application to process the received communication traffic for use by a law enforcement agency comprises decoding the communication traffic using a decoding process obtained using the application identifier.

4. The method of claim 1, wherein using the obtained information about the application to process the received communication traffic for use by a law enforcement agency comprises decrypting the communication traffic using a decryption process and a decryption key obtained using the application identifier.

5. The method of claim 1, wherein using the application identifier to obtain information about the application that generated the received communication traffic comprises using the application identifier as look-up parameter to perform a look-up operation on a database to obtain the information about the application from a database field correlated to the application identifier.

6. The method of claim 1, wherein receiving communication traffic subject to lawful interception comprises receiving the application identifier along with the communication traffic over an X2 interface of the wireless communication network when the communication traffic includes signaling traffic and over an X3 interface of the wireless communication network when the communication traffic includes media traffic.

7. The method of claim 1, further comprising including the application identifier in communication traffic transmitted by the mobile device.

8. A server for use in conducting lawful interception of communication traffic generated by an application on a mobile device transmitted over a wireless communication network, the server comprising:
a network interface; and
a processor coupled to the network interface and configured with processor-executable instructions to perform operations comprising:
receiving via the network interface communication traffic subject to lawful interception;
determining whether the received communication traffic includes an application identifier associated with the application that generated the received communication traffic;
using the application identifier to obtain information about the application that generated the received communication traffic; and
using the obtained information about the application to process the received communication traffic for use by a law enforcement agency authorized to receive the communication traffic.

9. The server of claim 8, wherein the obtained information about the application that generated the received communication traffic comprises one or more of a decoding process, a decryption process, and a decryption key.

10. The server of claim 8, wherein the processor is configured with processor-executable instructions to perform operations such that using the obtained information about the application to process the received communication traffic for use by a law enforcement agency comprises decoding the communication traffic using a decoding process obtained using the application identifier.

11. The server of claim 8, wherein the processor is configured with processor-executable instructions to perform operations such that using the obtained information about the application to process the received communication traffic for use by a law enforcement agency comprises decrypting the communication traffic using a decryption process and a decryption key obtained using the application identifier.

12. The server of claim 8, wherein the processor is configured with processor-executable instructions to perform operations such that using the application identifier to obtain information about the application that generated the received communication traffic comprises using the application identifier as look-up parameter to perform a look-up operation on a database to obtain the information about the application from a database field correlated to the application identifier.

13. The server of claim 8, wherein the processor is configured with processor-executable instructions to perform operations such that receiving via the network interface communication traffic subject to lawful interception comprises receiving the application identifier along with the communication traffic over an X2 interface of the wireless communication network when the communication traffic includes signaling traffic and over an X3 interface of the wireless communication network when the communication traffic includes media traffic.

14. A non-transitory server readable medium having stored thereon server-executable instructions configured to cause a server to perform operations for conducting lawful interception of communication traffic comprising:
receiving communication traffic subject to lawful interception;
determining whether the received communication traffic includes an application identifier associated with an application that generated the received communication traffic;
using the application identifier to obtain information about the application that generated the received communication traffic; and
using the obtained information about the application to process the received communication traffic for use by a law enforcement agency authorized to receive the communication traffic.

15. The non-transitory server readable medium of claim 14, wherein the obtained information about the application that generated the received communication traffic comprises one or more of a decoding process, a decryption process, and a decryption key.

16. The non-transitory server readable medium of claim 14, wherein the server is configured with server-executable instructions to perform operations such that using the obtained information about the application to process the received communication traffic for use by a law enforcement agency comprises decoding the communication traffic using a decoding process obtained using the application identifier.

17. The non-transitory server readable medium of claim 14, wherein the server is configured with server-executable instructions to perform operations such that using the obtained information about the application to process the received communication traffic for use by a law enforcement agency comprises decrypting the communication traffic using a decryption process and a decryption key obtained using the application identifier.

18. The non-transitory server readable medium of claim 14, wherein the server is configured with server-executable instructions to perform operations such that using the application identifier to obtain information about the application that generated the received communication traffic comprises using the application identifier as look-up parameter to perform a look-up operation on a database to obtain the information about the application from a database field correlated to the application identifier.

19. The non-transitory server readable medium of claim 14, wherein the server is configured with server-executable instructions to perform operations such that receiving via the network interface communication traffic subject to lawful interception comprises receiving the application identifier along with the communication traffic over an X2 interface of a wireless communication network when the communication traffic includes signaling traffic and over an X3 interface of the wireless communication network when the communication traffic includes media traffic.

20. A wireless communication system, comprising:
a wireless communication network;
a mobile device comprising:
a transceiver configured to communicate via the wireless communication network; and
a processor coupled to the transceiver and configured with processor executable instructions to perform operations comprising including in communication traffic transmitted by the mobile device an application identifier identifying an application executing on the mobile device and generating the communication traffic; and
a server for use in conducting lawful interception of communication traffic carried by the wireless communication network comprising:
a network interface configured to communicate with the wireless communication network; and
a server processor coupled to the network interface and configured with processor-executable instructions to perform operations comprising:
receiving via the network interface communication traffic from the mobile device subject to lawful interception;
using the application identifier included in the communication traffic by the mobile device to obtain information about the application that generated the received communication traffic; and
using the obtained information about the application to process the received communication traffic for use by a law enforcement agency authorized to receive the communication traffic.

21. The wireless communication system of claim 20, wherein the obtained information about the application that generated the received communication traffic comprises one or more of a decoding process, a decryption process, and a decryption key.

22. The wireless communication system of claim 20, wherein the server processor is configured with processor-executable instructions to perform operations such that using the obtained information about the application to process the received communication traffic for use by a law enforcement agency comprises decoding the communication traffic using a decoding process obtained using the application identifier.

23. The wireless communication system of claim 20, wherein the server processor is configured with processor-executable instructions to perform operations such that using the obtained information about the application to process the received communication traffic for use by a law enforcement agency comprises decrypting the communication traffic using a decryption process and a decryption key obtained using the application identifier.

24. The wireless communication system of claim 20, wherein the server processor is configured with processor-executable instructions to perform operations such that using the application identifier to obtain information about the application that generated the received communication traffic comprises using the application identifier as look-up parameter to perform a look-up operation on a database to obtain the information about the application from a database field correlated to the application identifier.

25. The wireless communication system of claim 20, wherein the server processor is configured with processor-executable instructions to perform operations such that receiving via the network interface communication traffic subject to lawful interception comprises receiving the application identifier along with the communication traffic over an X2 interface of the wireless communication network when the communication traffic includes signaling traffic and over an X3 interface of the wireless communication network when the communication traffic includes media traffic.
